(19) United States
(12) Patent Application Publication
(10) Pub. No.: US 2008/0088236 A1
(43) Pub. Date: Apr. 17, 2008

(54) Plasma display panel

(76) Inventor: Takahisa Mizuta, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/902,115

(22) Filed: Sep. 19, 2007

(30) Foreign Application Priority Data
Oct. 12, 2006 (KR) 10-2006-0099362

(51) Int. Cl. H01J 17/49

(52) U.S. Cl. 313/582

(57) ABSTRACT

Example embodiments relate to a plasma display panel including a first substrate and a second substrate configured to face each other, a plurality of discharge cells between the first and second substrates, each discharge cells may include a cross-section having a long axis and a short axis, a plurality of first sustaining electrodes and a plurality of second sustaining electrodes, and a plurality of address electrodes crossing the first and second sustaining electrodes. Each of the plurality of first and second sustaining electrodes may include a protrusion extending toward the long axis in a discharge region of the discharge cell.

### BACKGROUND OF THE INVENTION

1. Field of the Invention

Example embodiments relate to a plasma display panel (PDP), more particularly, example embodiments relate to a plasma display panel PDP having a structure with reduced discharge distance and reduced amount of emitting unit light.

2. Description of the Related Art

A conventional plasma display panel (PDP) may be a flat panel display that may be capable of displaying images by exciting photoluminescent elements (i.e., phosphors) using ultraviolet (UV) light generated by gas discharge, e.g., applying voltage to a discharge gas to generate discharge and excite the photoluminescent elements to emit visible light. PDPs may generally be the preferred next generation thin flat panel display due to its thin-structure, and large, high-resolution screen.

However, in the conventional PDP, a distance between sustaining electrodes may be wide, which may require a high discharge voltage during a sustaining discharge. The high discharge voltage may lead to high power consumption.

Further, discharge cells (where discharge may be generated) may have rectangular cross-sections parallel to the PDP, e.g., a long axis and a short axis. In most conventional PDPs, the first and second sustaining electrodes may extend parallel to the short axes. Further, protrusions may be formed from the first sustaining electrodes toward the second sustaining electrodes, and similarly, from the second sustaining electrodes toward the first sustaining electrodes, so that discharge may be generated between the protrusions. Also, because the distance between the protrusions of the first and second sustaining electrodes may correspond to a length of the long axis of the discharge cells, the distance for discharging may be large, which may produce high sustaining discharge voltages and power consumption. Further, due to the high sustaining discharge voltage, the unit light emitting amount, e.g., a light emitting amount per one light emission may also be large. As a result, it may be difficult to realize fine gradation, which may be realized by controlling a frequency of light emission, which ultimately may cause deterioration in the quality of realized images.

Accordingly, in order to reduce the power consumption of the PDP, a small distance between sustaining electrodes should be utilized to generate the sustaining discharge. Further, the amount of emitting unit light should also be small so as to provide a fine gradation.

### SUMMARY OF THE INVENTION

Example embodiments are therefore directed to a plasma display panel, which substantially overcomes one or more of the problems due to the limitations and disadvantages of the related art.

It is therefore a feature of example embodiments to provide a plasma display panel with small discharge distances between sustaining electrodes.

It is therefore another feature of example embodiment to provide a plasma display panel with reduced amount of emitting unit light.

At least one of the above and other features and advantages of example embodiments may be to provide a plasma display panel including a first substrate and a second substrate configured to face each other, a plurality of discharge cells between the first and second substrates, each discharge cells may include a cross-section having a long axis and a short axis, a plurality of first sustaining electrodes and a plurality of second sustaining electrodes, and a plurality of address electrodes crossing the first and second sustaining electrodes. Each of the plurality of first and second sustaining electrodes may include a protrusion extending toward the long axis in a discharge region of the discharge cell.

The plurality of first and second sustaining electrodes may extend parallel to the short axis of the discharge cells to alternately correspond to non-discharge regions of the discharge cells.

The protrusion may include first protrusions and second protrusions. The first protrusions may extend parallel to the long axis of the discharge cells to correspond to non-discharge regions of the discharge cells, and the second protrusions may extend from the first protrusions to correspond to the discharge regions of the discharge cells.

The first protrusions of the first sustaining electrodes may be symmetrical with respect to the extension direction of the first sustaining electrodes, and the first protrusions of the second sustaining electrodes may be symmetrical with respect to the extension direction of the second sustaining electrodes.

The first protrusions of the first sustaining electrodes and the first protrusions of the second sustaining electrodes may alternate with respect to the extension direction of the first and second sustaining electrodes.

The first protrusions may be generally perpendicular to the first and second sustaining electrodes.

The address electrodes may extend parallel to the long axis of the discharge cells. The address electrodes may be formed to extend between the first protrusions of the first sustaining electrodes and the first protrusions of the second sustaining electrodes, the address electrodes corresponding to the discharge cells.

The first protrusions of the first sustaining electrodes may be alternately extending to a first side and a second side with respect to the extension direction of the first sustaining electrodes, and the first protrusions of the second sustaining electrodes may be alternately extending to a first side and a second side with respect to the extension direction of the second sustaining electrodes.

The first protrusions on the first side the first sustaining electrodes and the first protrusions on the second side of the second sustaining electrodes may alternate with respect to the extension direction of the first and second sustaining electrodes.

The address electrodes may be formed to extend between the first protrusions of the first sustaining electrodes and the first protrusions of the second sustaining electrodes, the address electrodes corresponding to the discharge cells.

The plurality of first and second sustaining electrodes may extend parallel to the long axis of the discharge cells to alternately correspond to non-discharge regions of the discharge cells.

The second protrusions may be symmetrical with respect to the protrusion direction of the first protrusions.

The second protrusions may be formed of a transparent conductive material.

The second protrusions may be formed of the same material as the first protrusions.

The first sustaining electrodes, the second sustaining electrodes; and the first protrusions may be formed on upper portions of barrier ribs.

A cross-section of each of the discharge cells parallel to the first substrate may be generally rectangular shaped.

The plasma display panel may further include a photoluminescent layer disposed in each of the discharge cells.

### BRIEF DESCRIPTION OF THE DRAWINGS

The above and other features and advantages of the example embodiments will become more apparent to those of ordinary skill in the art by describing in detail example embodiments thereof with reference to the attached drawings, in which:

FIG. 1 illustrates an exploded perspective view of a plasma display panel (PDP) according to an example embodiment;

FIG. 2 illustrates a plan view of a positional relationship of barrier ribs and discharging electrodes of the PDP illustrated in FIG. 1;

FIG. 3 illustrates a plan view of a positional relationship of barrier ribs and discharging electrodes of a PDP, according to another example embodiment;

FIG. 4 illustrates a plan view of a positional relationship of barrier ribs and discharging electrodes of a PDP, according to another example embodiment;

FIG. 5 illustrates a plan view of a positional relationship of barrier ribs and discharging electrodes of a PDP, according to another example embodiment;

FIG. 6 illustrates a plan view of a positional relationship of barrier ribs and discharging electrodes of a PDP, according to another example embodiment; and

FIG. 7 illustrates a plan view of a positional relationship of barrier ribs and discharging electrodes of a PDP, according to another example embodiment.

### DETAILED DESCRIPTION OF THE INVENTION

Korean Patent Application No. 10-2006-0099362, filed on Oct. 12, 2006 in the Korean Intellectual Property Office, and entitled: “Plasma Display Panel,” is incorporated by reference herein in its entirety.

In a conventional PDP, a cross-section of the discharge cells, which may be parallel to the PDP, may have a rectangular shape, e.g., a long axis (t) and a short axis (s). Further, the first and second sustaining electrodes may extend parallel to the short axis (s) of the rectangular cross-section of the discharge cells. Also, protrusions may be formed from the first sustaining electrodes toward the second sustaining electrodes, and protrusions may be formed from the second sustaining electrodes toward the first sustaining electrodes, so as to generate discharge between the protrusions. Because the distance between the protrusions of the first and second sustaining electrodes may correspond to the long axis (t) of the discharge cells, the distance for discharging may also be elongated. As a result, the sustaining discharge voltage, and consequently, power consumption, may be high. Further, due to the high sustaining discharge voltage, the unit light emitting amount, e.g., the light emitting amount per one light emission, may be large. Accordingly, it may be difficult to produce fine gradation, e.g., due to controlling of the frequency of light emission, which may deteriorate the quality of the produced images.

In order to solve the above problems, example embodiments disclose a PDP having first sustaining electrodes and second sustaining electrodes extending parallel to a short axis (s) of discharge cells. Because a distance between second protrusions of the first sustaining electrodes and second protrusions of the second sustaining electrodes may correspond to the length of the short axis (s) of the discharge cell, the discharge distance between the second protrusions of the first sustaining electrodes and the second protrusions of the second sustaining electrodes may be relatively shorter than the conventional PDP. Accordingly, the sustaining discharge voltage may be reduced, and thus, the power consumption may also be significantly reduced. Also, as the sustaining discharge voltage is reduced, the sustaining discharge voltage may be occasionally controlled, and thus, the unit light emitting amount may be reduced. Further, as the unit light emitting amount is reduced, fine gradation may be provided so as to significantly improve the quality of the image of a display device. Further, as portions of the first and second sustaining electrodes (except for the second protrusions), are disposed in non-discharge regions, light loss may be prevented and/or reduced, when light generated in the discharge cells is output to the outside.

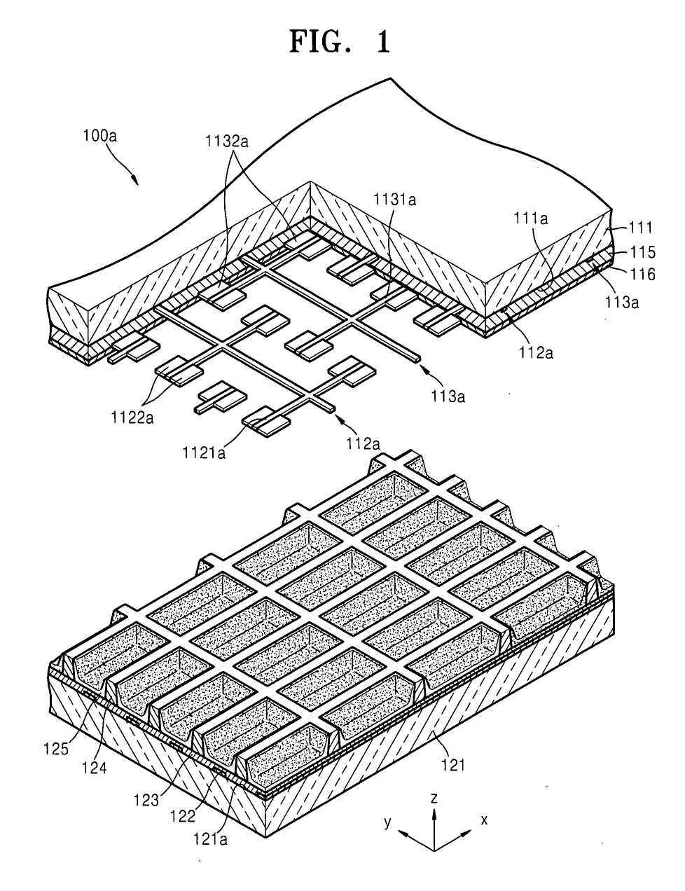

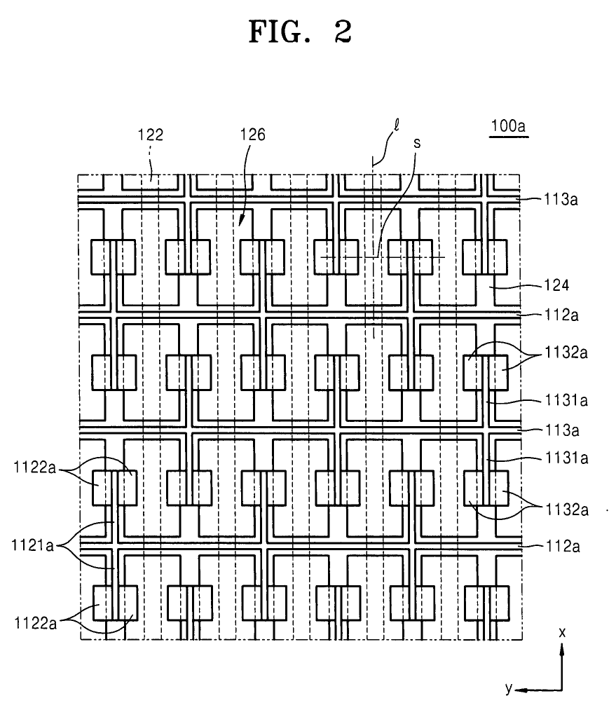

FIG. 1 illustrates an exploded perspective view of a plasma display panel (PDP) 100a according to an example embodiment. FIG. 2 illustrates a plan view of a positional relationship of barrier ribs 124 and discharging electrodes, e.g., first sustaining electrodes 112a, second sustaining electrodes 113a, and address electrodes 122, of the PDP 100a illustrated in FIG. 1.

Referring to FIGS. 1 and 2, a first substrate 111 and a second substrate 121 may be disposed to face each other. The first and second substrates 111 and 121 may be formed of a plastic material and/or a transparent material, e.g., a glass. It should be appreciated that other materials may be used to form the first and second substrates 111 and 121, such as, but not limited to, a soda lime glass, a semi-transmissible substrate, a reflective substrate, or a colored substrate. The barrier ribs 124 may be formed between the first and second substrates 111 and 121. In an example embodiment, (as shown in FIG. 1), the barrier ribs 124 may be formed on a surface of the second substrate 121 toward the first substrate 111; however, it should be appreciated that the barrier ribs 124 may also be formed on a surface of the first substrate 111 toward the second substrate 121. It should further be appreciated that other various modifications of the barrier ribs 124 may be employed.

The barrier ribs 124, the first substrate 111, and the second substrate 121 may define discharge cells 126, e.g., where gas discharge may be generated (as shown in FIG. 2). Further, the barrier ribs 124 may have a generally rectangular cross-section, e.g., a long axis (t) and a short axis (s), which may be parallel to the first substrate 111 and/or the second substrate 121. Although each of the discharge cells 126 are illustrated as having a generally rectangular cross-section, it should be appreciated that other cross-sections may be employed, such as, but not limited to, an ellipse, a polygon, and/or an oval as long as there is a respective long axis and short axis.

The PDP 100a may include the first and second sustaining electrodes 112a and 113a extending in one direction to correspond to the discharge cells 126. Further, the first sustaining electrodes 112a and the second sustaining electrodes 113a may extend in the y direction, e.g., parallel to the short axis (s) of the discharge cells 126 (as shown in FIG. 2). The first and second sustaining electrodes 112a and 113a may be formed to alternately correspond to non-discharge regions of the discharge cells 126. The non-discharge regions of the discharge cells 126 may refer to a space where no discharge is generated. For example, the non-discharge regions may be at rims of the discharge regions, e.g., upper portions of the barrier ribs 124. Accordingly, in an example embodiment, the first and second sustaining electrodes 112a and 113a may be formed on the upper portions of the barrier ribs 124.

The first sustaining electrodes 112a may include first protrusions 1121a extending parallel to the long axis (l), so as to correspond to the non-discharge regions of the discharge cells 126, and second protrusions 1122a extending from the first protrusions 1121a toward the discharge regions of the discharge cells 126. Similarly, the second sustaining electrodes 113a may include first protrusions 1131a extending parallel to the long axis (t), so as to correspond to the non-discharge regions of the discharge cells 126, and second protrusions 1132a extending from the first protrusions 1131a toward the discharge regions of the discharge cells 126.

In an example embodiment, the first protrusions 1121a and 1131a may be a structure of a thin elongated shaped member, and the second protrusions 1122a and 1132a may be a structure of a fin-like shaped member.

The first protrusions 1121a of the first sustaining electrodes 112a may be symmetrical with respect to an extension direction (y direction) of the first sustaining electrodes 112a. In other words, the portions of the first sustaining electrodes 112a extending in the y direction and the first protrusions 1121a of the first sustaining electrodes 112 may be perpendicular to each other. Similarly, the first protrusions 1131a of the second sustaining electrodes 113a may be symmetrical with respect to the extension direction (y direction) of the second sustaining electrodes 113a. The first protrusions 1121a of the first sustaining electrodes 112a and the first protrusions 1131a of the second sustaining electrodes 113a may alternate with respect to the extension direction (y direction). The second protrusions 1122a and 1132a may be symmetrical with respect to the protrusion direction (x direction or −x direction) of the first protrusions 1121a and 1131a.

The first sustaining electrodes 112a and the second sustaining electrodes 113a may be formed on a surface of the first substrate 111 toward the second substrate 121, however, it should be appreciated that the first sustaining electrodes 112a and the second sustaining electrodes 113a may be disposed at other locations, e.g., the first sustaining electrodes 112a and the second sustaining electrodes 113a may be formed on the barrier ribs 124.

The first sustaining electrodes 112a and the second sustaining electrodes 113a may be electrodes for sustaining discharge generated between the first sustaining electrodes 112a and the second sustaining electrodes 113a, so as to generate images of the PDP 100a.

The first sustaining electrodes 112a and the second sustaining electrodes 113a, including the first protrusions 1121a and 1131a, respectively, may be formed of a material, e.g., a conductive metal, having a low resistance and high electrical conductivity. Examples of the conductive metal may be, such as, but not limited to, silver (Ag), copper (Cu), gold (Au), and/or aluminum (Al). The second protrusions 1122a and 1132a of the first sustaining electrodes 112a and the second sustaining electrodes 113a, respectively, may be formed of a transparent conductive material, e.g., indium tin oxide (ITO), so that light generated inside the PDP 100a may be output to the outside via the first substrate 111. Further, portions of the first and second sustaining electrodes 112a and 113a (except for the second protrusions 1122a and 1132a), may be formed of a material containing a black additive, so as to improve a contrast of the PDP 100a. Alternatively, portions of the first and second sustaining electrodes 112a and 113a may be a multi-layer structure, including a layer formed of the dark additive material. The first sustaining electrodes 112a and the second sustaining electrodes 113a may be connected to a connection cable arranged at the rim of the PDP 100a to receive power supply, and to electrically connect the first sustaining electrodes 112a to each other. In an alternative embodiment, odd-numbered first sustaining electrodes 112a may be electrically connected to each other and even-numbered first sustaining electrodes 112a may be electrically connected to each other. Similarly, the second sustaining electrodes 113a may have the same structure as the first sustaining electrodes 112a as discussed above.

The first sustaining electrodes 112a and the second sustaining electrodes 113a may be covered by a first dielectric layer 115 formed on the first substrate 111, so as to prevent and/or reduce the first sustaining electrodes 112 and the second sustaining electrodes 113a from directly being electrically connected to each other, and to prevent and/or reduce charged particles from colliding with each other, which may damage the first and second sustaining electrodes 112a and 113a. The dielectric layer 115 may be formed of a transparent dielectric material, e.g., a mixture of PbO, B₂O₃, SiO₂.

Further, at least a surface portion of the first dielectric layer 115 may be covered by a protection layer 116. In an example embodiment, as shown FIG. 1, an entire surface of the first dielectric layer 115 may be covered by the protection layer 116. The protection layer 116 may be formed by depositing a material, e.g., magnesium oxide (MgO), on the first dielectric layer 115. The protection layer 116 may also activate discharge by emitting secondary electrons (e.g., increase emission of secondary electrons), in addition to protecting the first dielectric layer 115.

The address electrodes 122 may extend parallel to the long axis (l) of the discharge cells 126, so as to cross the first sustaining electrodes 112a and the second sustaining electrodes 113a. As illustrated in FIGS. 1 and 2, the address electrodes 122 may be formed to extend between the first protrusions 1121a of the first sustaining electrodes 112a and the first protrusions 1131a of the second sustaining electrodes 113a, so that the address electrodes 122 may correspond to the discharge cells 126. By such an arrangement, the address electrodes 122 may generate address discharge between at least one of the first sustaining electrodes 112a and the second sustaining electrodes 113a, and may also generate sustaining discharge between the first sustaining electrode 112a and the second sustaining electrode 113a.

The address electrodes 122 may be disposed on a surface of the second substrate 121 toward the first substrate 111. Further, a second dielectric layer 123 may be formed to cover the address electrodes 122 in order to prevent and/or reduce the charged particles from colliding with the address electrodes 122 and damaging the address electrodes 122 during discharge. The second dielectric layer 123 may be formed of a dielectric material, e.g., PbO, B₂O₃, SiO₂, etc., so as to induce the charged particles.

A photoluminescent layer 125 (e.g., a phosphor layer) may be formed inside each of the discharge cells 126 (as illustrated in FIG. 2), e.g., on a top surface of the second dielectric layer 123 and on sidewalls of the barrier ribs 124. The photoluminescent layer 125 may include a phosphor layer emitting red light, e.g., Y(V,P)O₄:Eu, a phosphor layer emitting green light, e.g., Zn₂SiO₄:Mn, and a phosphor layer emitting blue light, e.g., BAM:Eu. The photoluminscent layer 125 may further include a phosphor paste, e.g., a mixed solvent and binder. The photoluminscent layer 125 may then be plasticize, e.g., by drying.

Although the photoluminscent layer 125 may be illustrated as being formed on the upper surface of the second dielectric layer 123 and on the sidewalls of the barrier ribs 124, it should be appreciated that the photoluminscent layer 125 may be formed on other location of the discharge cells 126.

Further, the photoluminescent layer 125 of the PDP 100a may be disposed on inner surfaces of the discharge cells 126, so that voltage applied to the discharge gas may trigger ultraviolet (UV) light generation, followed by emission of visible light by the photoluminescent layer 125. Exemplary discharge gas may be neon (Ne), xenon (Xe), and/or helium (He). Alternatively, the discharge gases may be a combination gas, e.g., neon-xeon (Ne—Xe) mixed gas containing approximately 5-15% of Xe. It should be appreciated that at least a portion of Ne may be substituted with He in accordance to usage.

It should also be appreciated that other gases may be used as the discharge gas. It should also be appreciated that the inside of the discharge cells 126 may be in a vacuum.

It should be appreciated that the PDP 100a may be driven in various manners, i.e., by an alternate lighting of surface (ALiS) method.

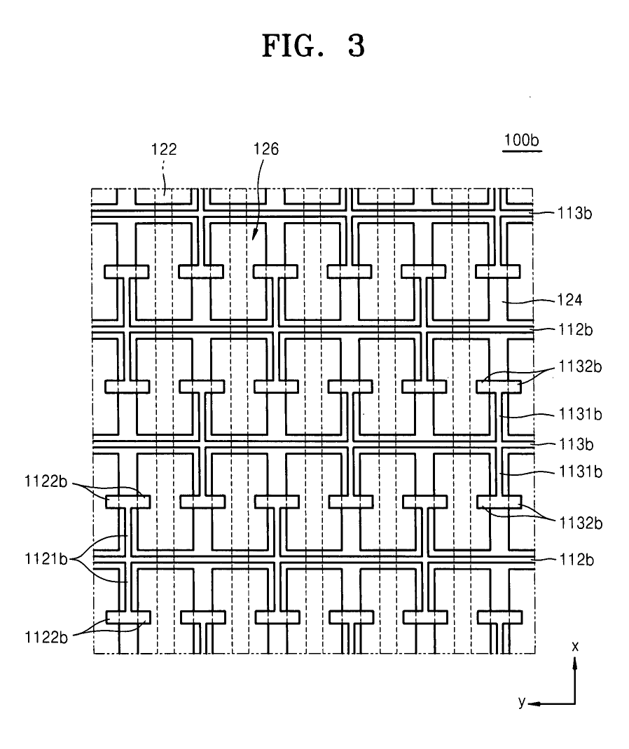

FIG. 3 is a plan view of a positional relationship of the barrier ribs 124 and the discharge electrodes, e.g., the first sustaining electrodes 112b, the second sustaining electrodes 113b and the address electrodes 122 of a PDP 100b, according to another example embodiment.

The PDP 100b illustrated in FIG. 3 may be different from the PDP 100a illustrated in FIG. 2 in that the second protrusions 1122b and 1132b of the first and second sustaining electrodes 112b and 113b, respectively, may be formed of the same transparent materials, e.g., an opaque conductive material, as the first protrusions 1121b and 1131b of the first and second sustaining electrodes 112b and 113b, respectively.

Further, a size of the second protrusions 1122b and 1132b illustrated in FIG. 3 may be smaller than a size of the second protrusions 1122a and 1132a illustrated in FIG. 2. Smaller second protrusions 1122b and 1132b may prevent and/or reduce light loss, when light generated in the discharge cells 126 is output to the outside. Further, even when the size of the second protrusions 1122b and 1132b extending toward the discharge regions of the discharge cells 126 from the first protrusions 1121b and 1131b, respectively, is reduced, the reduced discharge distance between the second protrusions 1122b of the first sustaining electrodes 112b and the second protrusions 1132b of the second sustaining electrodes 113b may be maintained because the distance between the second protrusions 1122b of the first sustaining electrodes 112b and the second protrusions 1132b of the second sustaining electrodes 113b may correspond to the length of the short axis (s) of the discharge cells 126. As a result, sustaining discharge may be generated at a low voltage, and thus, the power consumption may be significantly reduced.

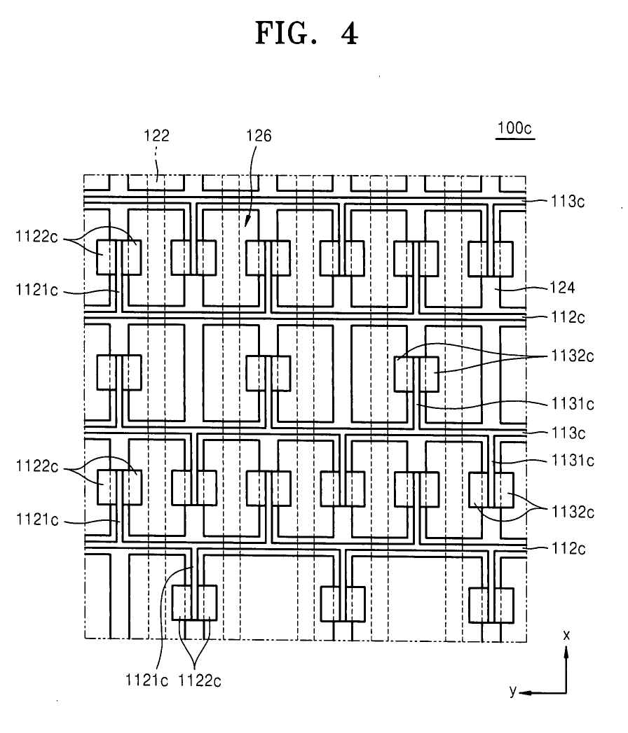

FIG. 4 is a plan view of a positional relationship of the barrier ribs 124 and the discharge electrodes, e.g., the first sustaining electrodes 112c, the second sustaining electrodes 113c and the address electrodes 122, of a PDP 100c, according to another example embodiment.

The PDP 100c illustrated in FIG. 4 may be different from the PDPs 100a and 100b illustrated in FIGS. 2 and 3, respectively, in the arrangement of the first protrusions 1121c and 1131c of the first and second sustaining electrodes 112c and 113c, respectively. In the PDPs 100a and 100b illustrated in FIGS. 2 and 3, respectively, the first protrusions 1121a and 1121b of the first sustaining electrodes 112a and 112b may be symmetrical with respect to the extension direction (y direction) of the first sustaining electrodes 112a and 112b. Further, the extension direction of the first sustaining electrodes 112a and 112b in the y direction and the extension direction of the first protrusions 1121a and 1121b of the first sustaining electrodes 112a and 112b may be perpendicular to each other. The same arrangement may apply to the second sustaining electrodes 113a and 113b.

The PDP 100c illustrated in FIG. 4 may be different from the PDP 100a and 100b illustrated in FIGS. 2 and 3, respectively, in that the first protrusions 1121c of the first sustaining electrodes 112c may alternately extend to a first side and a second side with respect to the extension direction (y direction) of the first sustaining electrodes 112c. The first side and the second side respectively may refer to a (+x) direction and a (−x) direction. Similarly, the first protrusions 1131c of the second sustaining electrodes 113c may also be alternately protruding to the first side (+x direction) and the second side (−x direction) with respect to the extension direction (y direction) of the second sustaining electrode 113c. Further, the first protrusions 1121c extending to the first side (+x direction) of the first sustaining electrode 112c and the first protrusions 1131c extending to the second side (−x direction) of the second sustaining electrodes 113c may alternate with respect to the extension direction (y direction) of the first and second sustaining electrodes 112c and 113c. The address electrodes 122 may be formed to extend between the first protrusions 1121 of the first sustaining electrodes 112c and the first protrusions 1131c of the second sustaining electrodes 113c.

Further, in the PDP 100c illustrated in FIG. 4, the second protrusions 1122c of the first sustaining electrodes 112c and the second protrusions 1132c of the second sustaining electrodes 113c may extend in the direction of the short axis (s) of the discharge cells 126, and thus, the discharge distance between the second protrusions 1122c of the first sustaining electrodes 112c and the second protrusions 1132c of the second sustaining electrodes 113c may be reduced. Accordingly, the sustaining discharge voltage may be reduced, and thus, the power consumption may be significantly reduced. Further, because the sustaining discharge voltage may be reduced, there may not be any need to control the sustaining discharge voltage, and thus, the unit light emitting amount may also be reduced, e.g., when the unit light emitting amount is reduced, fine gradation may be possible. As a result, the image quality of produced images of the display device may be significantly improved. Further, because portions of the first and second sustaining electrodes 112c and 113c (except for the second protrusions 1122c and 1132c), may be disposed in non-discharge regions, light loss may be prevented and/or reduced, when light generated in the discharge cells 126 is output to the outside.

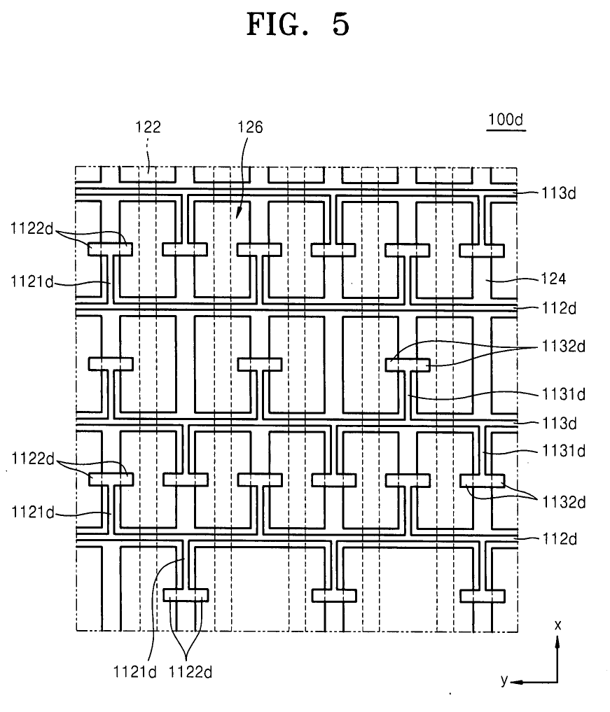

FIG. 5 illustrates a plan view of a positional relationship of the barrier ribs 124 and the discharging electrodes, e.g., the first sustaining electrodes 112d, the second sustaining electrodes 113 and the address electrodes 122 of a PDP 100d, according to another example embodiment.

The PDP 100d illustrated in FIG. 5 may be different from the PDP 100c illustrated in FIG. 4 in that the second protrusions 1122d and 1132d, of the first and second sustaining electrodes 112d and 113d, respectively, may be formed of the same transparent material, e.g., an opaque conductive material as the first protrusions 1121d and 1131d of the first and second sustaining electrodes 112d and 113d, respectively.

Further, a size of the second protrusions 1122d and 1132d illustrated in FIG. 5 may be smaller than a size of the second protrusions 1122c and 1132c illustrated in FIG. 4. Smaller second protrusions 1122d and 1132d may prevent and/or reduce light loss when light generated in the discharge cells 126 is output to the outside. Further, even when the size of the second protrusions 1122d and 1132d protruding toward the discharge regions of the discharge cells 126 from the first protrusions 1121d and 1131d is reduced, the small discharge distance between the second protrusions 1122d of the first sustaining electrodes 112d and the second protrusions 1132d of the second sustaining electrodes 113d may be maintained because the distance between the second protrusions 1122d of the first sustaining electrodes 112d and the second protrusions 1132d of the second sustaining electrodes 113d may correspond to the length of the short axis (s) of the discharge cells 126. As a result, sustaining discharge may be generated at a low voltage, and thus, the power consumption may be significantly reduced.

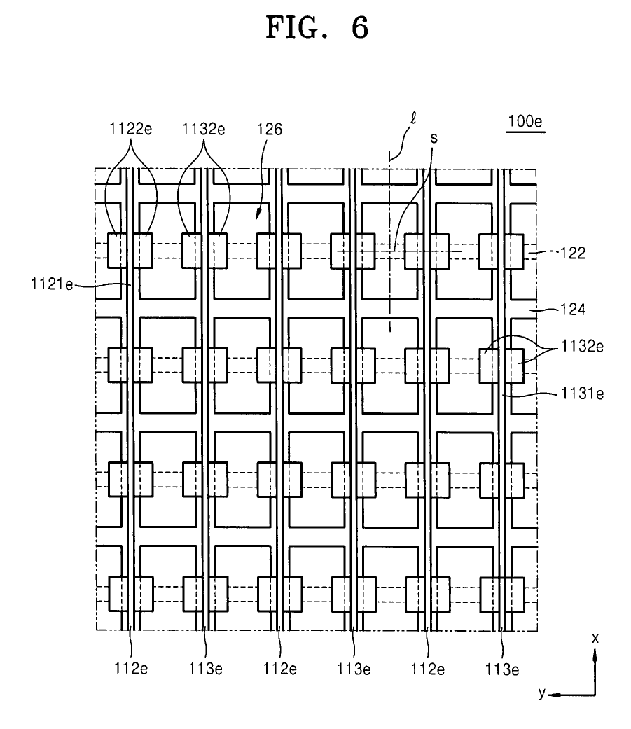

FIG. 6 illustrates a plan view of a positional relationship of the barrier ribs 124 and discharge electrodes, e.g., the first sustaining electrodes 112e, the second sustaining electrodes 113e and the address electrodes 122 of a PDP 100e according to another example embodiment.

The PDP 100e illustrated in FIG. 6 may be different from the PDPs 100a through 100d described in the above example embodiments (e.g., the first sustaining electrodes 112a-d and the second sustaining electrodes 113a-d may extend in a direction parallel to the long axis (t) of the discharge cells 126 in x direction).

The first and second sustaining electrodes 112e and 113e may include protrusions 1122e and 1132e, respectively, protruding toward discharge regions of the discharge cells 126. The protrusions 1122e of the first sustaining electrodes 112 may be symmetrical with respect to the extension direction of the first sustaining electrodes 112e (x direction), and similarly, the protrusions 1132e of the second sustaining electrodes 113e may also be symmetrical with respect to the extension direction of the second sustaining electrodes 113e (y direction). The first sustaining electrodes 112e and the second sustaining electrodes 113e may be formed of a material, e.g., a conductive metal, having a low resistance and high electrical conductivity. Examples of the conductive metal may be, such as, but not limited to, silver (Ag), copper (Cu), gold (Au), and/or aluminum (Al). The protrusions 1122e and 1132e may be formed of a transparent conductive material, e.g., an indium tin oxide (ITO). The address electrodes 122 may extend parallel to the short axis (s) of the discharge cells 126 crossing the first and second sustaining electrodes 112e and 113e.

Further, in the PDP 100e illustrated in FIG. 6, the protrusions 1122e of the first sustaining electrodes 112e and the protrusions 1132e of the second sustaining electrodes 113e may extend in the direction of the short axis (s) of the discharge cells 126, and thus, the discharge distance between the protrusions 1122e of the first sustaining electrodes 112e and the protrusions 1132e of the second sustaining electrodes 113 may be reduced. As a result, the sustaining discharge voltage may be reduced, and thus, the power consumption may be significantly reduced. Further, because the sustaining discharge voltage may be reduced, there may not be any need to control the sustaining discharge voltage, and thus, the unit light emitting amount may be reduced, e.g. when the unit light emitting amount is reduced, fine gradation may be possible. As a result, the image quality of produced images of the display device may be significantly improved.

Further, because portions of the first and second sustaining electrodes 112e and 113e (except for the protrusions 1122e and 1132e), may be disposed in non-discharge regions, light loss may be prevented and/or reduced, when light generated in the discharge cells 126 is output to the outside.

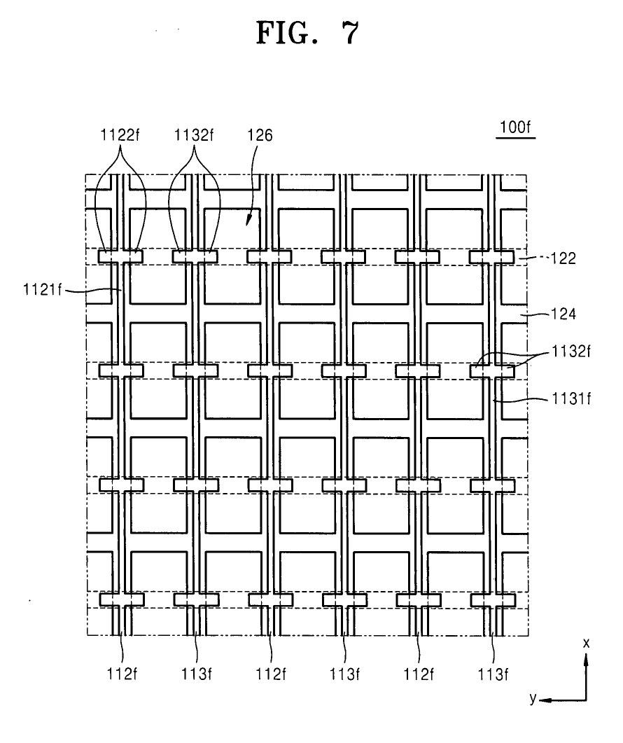

FIG. 7 illustrates a plan view of a positional relationship of the barrier ribs 124 and discharge electrodes, e.g., the first sustaining electrodes 112f, the second sustaining electrodes 113f, and the address electrodes 122 of a PDP 100f, according to another example embodiment.

The PDP 100f illustrated in FIG. 7 may be different from the PDP 100e illustrated in FIG. 6 in that the protrusions 1122f and 1132f of the first and second sustaining electrodes 112f and 113f, respectively, may be formed of same transparent material, e.g., an opaque conductive material (indium tin oxide ITO), from other portions of the first and second sustaining electrodes 112 and 113.

Further, a size of the protrusions 1122f and 1132f illustrated in FIG. 7 may be smaller than a size of the protrusions 1122e and 1132e illustrated in FIG. 6. Smaller second protrusions 1122f and 1132f may prevent and/or reduce light loss, when light generated in the discharge cells 126 is output to the outside. Further, even when the size of the protrusions 1122f and 1132f protruding toward the discharge regions of the discharge cells 126, respectively, is reduced, the close discharge distance between the protrusions 1122f of the first sustaining electrodes 112f and the protrusions 1132f of the second sustaining electrodes 113f may be maintained because the distance between the protrusions 1122f of the first sustaining electrodes 112f and the protrusions 1132f of the second sustaining electrodes 113f may correspond to the length of the short axis (s) of the discharge cells 126. As a result, sustaining discharge may be generated at a low voltage, and thus, the power consumption may be significantly reduced.

Thus, example embodiments relate to a PDP having a short discharge distance, and reducing the amount of emitting unit light.

In the figures, the dimensions of layers and regions may be exaggerated for clarity of illustration. It will also be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Further, it will be understood that when a layer is referred to as being “under” or “above” another layer, it can be directly under or directly above, and one or more intervening layers may also be present. In addition, it will also be understood that when a layer is referred to as being “between” two layers, it can be the only layer between the two layers, or one or more intervening layers may also be present. Like numbers refer to like elements throughout. As used herein, the term “and/or” includes any and all combinations of one or more of the associated listed items.

It will also be understood that, although the terms “first” and “second” etc. may be used herein to describe various elements, structures, components, regions, layers and/or sections, these elements, structures, components, regions, layers and/or sections should not be limited by these terms. These terms are only used to distinguish one element, structure, component, region, layer and/or section from another element, structure, component, region, layer and/or section. Thus, a first element, structure, component, region, layer or section discussed below could be termed a second element, structure, component, region, layer or section without departing from the teachings of example embodiments.

Spatially relative terms, such as “beneath,” “below,” “lower,” “above,” “upper” and the like, may be used herein for ease of description to describe one element or feature relationship to another element(s) or feature(s) as illustrated in the figures. It will be understood that the spatially relative terms are intended to encompass different orientations of the device in use or operation in addition to the orientation depicted in the figures. For example, if the device in the figures is turned over (or upside down), elements or layers described as “below” or “beneath” other elements or layers would then be oriented “above” the other elements or layers. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. Further, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Example embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel, comprising:
a first substrate and a second substrate configured to face each other;
a plurality of discharge cells between the first and second substrates, each discharge cell includes a cross-section having a long axis and a short axis;
a plurality of first sustaining electrodes and a plurality of second sustaining electrodes; and
a plurality of address electrodes crossing the first and second sustaining electrodes,
wherein each of the plurality of first and second sustaining electrodes includes a protrusion extending toward the long axis in a discharge region of the discharge cell.

2. The plasma display panel as claimed in claim 1, wherein the plurality of first and second sustaining electrodes extends parallel to the short axis of the discharge cells to alternately correspond to non-discharge regions of the discharge cells.

3. The plasma display panel as claimed in claim 2, wherein the protrusion includes first protrusions and second protrusions.

4. The plasma display panel as claimed in claim 3, wherein the first protrusions extend parallel to the long axis of the discharge cells to correspond to non-discharge regions of the discharge cells, and the second protrusions extends from the first protrusions towards the discharge region of the discharge cells.

5. The plasma display panel as claimed in claim 4, wherein the first protrusions of the first sustaining electrodes are symmetrical with respect to an extension direction of the first sustaining electrodes, and the first protrusions of the second sustaining electrodes are symmetrical with respect to an extension direction of the second sustaining electrodes.

6. The plasma display panel as claimed in claim 5, wherein the first protrusions of the first sustaining electrodes and the first protrusions of the second sustaining electrodes alternate with respect to the extension direction of the first and second sustaining electrodes.

7. The plasma display panel as claimed in claim 5, wherein the first protrusions are generally perpendicular to the first and second sustaining electrodes.

8. The plasma display panel as claimed in claim 5, wherein the address electrodes extend parallel to the long axis of the discharge cells.

9. The plasma display panel as claimed in claim 8, wherein the address electrodes are formed to extend between the first protrusions of the first sustaining electrodes and the first protrusions of the second sustaining electrodes, the address electrodes corresponding to the discharge cells.

10. The plasma display panel as claimed in claim 3, wherein the first protrusions of the first sustaining electrodes are alternately extending to a first side and a second side with respect to the extension direction of the first sustaining electrodes, and the first protrusions of the second sustaining electrodes are alternately extending to a first side and a second side with respect to the extension direction of the second sustaining electrodes.

11. The plasma display panel as claimed in claim 10, wherein the first protrusions on the first side of the first sustaining electrodes and the first protrusions on the second side of the second sustaining electrodes alternate with respect to the extension direction of the first and second sustaining electrodes.

12. The plasma display panel as claimed in claim 11, wherein the address electrodes are formed to extend between the first protrusions of the first sustaining electrodes and the first protrusions of the second sustaining electrodes, the address electrodes corresponding to the discharge cells.

13. The plasma display panel as claimed in claim 3, wherein the plurality of first and second sustaining electrodes extends parallel to the long axis of the discharge cells to alternately correspond to non-discharge regions of the discharge cells.

14. The plasma display panel as claimed in claim 13, wherein the protrusions of the first sustaining electrodes are symmetrical with respect to the extension direction of the first sustaining electrodes, and the protrusions of the second sustaining electrodes are symmetrical with respect to the extension direction of the second sustaining electrodes.

15. The plasma display panel as claimed in claim 3, wherein the second protrusions are symmetrical with respect to the extending direction of the first protrusions.

16. The plasma display panel as claimed in claim 3, wherein the second protrusions are formed of a transparent conductive material.

17. The plasma display panel as claimed in claim 3, wherein the second protrusions are formed of the same material as the first protrusions.

18. The plasma display panel as claimed in claim 3, wherein the first sustaining electrodes, the second sustaining electrodes, and the first protrusions are formed on upper portions of barrier ribs.

19. The plasma display panel as claimed in claim 3, wherein a cross-section of each of the discharge cells parallel to the first substrate is generally rectangular in shape.

20. The plasma display panel as claimed in claim 1, further comprising a photoluminescent layer disposed in each of the discharge cells.
